(19) United States
(12) Patent Application Publication
(10) Pub. No.: US 2007/0223407 A1
(43) Pub. Date: Sep. 27, 2007

(54) Far echo rejection for a facsimile modem control channel

(76) Inventor: Terry L. Engel, Bristol, CT (US)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 11/386,366

(22) Filed: Mar. 22, 2006

(51) Int. Cl. H04B 3/20

(52) U.S. Cl. 370/286; 370/201

(57) ABSTRACT

A method and system for far echo rejection for a fax modem control channel is disclosed for eliminating far echo signals during a fax transmission with a fax modem using a control channel and a primary channel for transmitting data. The far echo rejection may be achieved even if the fax modem standard utilized does not include far echo training. An echo detection control frame is transmitted during the initial fax transmission control channel communications. Far echo rejection can be achieved by monitoring for an echo of the sent echo detection control frame, measuring the detected echo level, recording the echo level, and rejecting signals below a threshold based upon the echo level. Signals at or above the echo threshold level are treated as fax signals while signals below the threshold level are assumed to be far echoes.

### TECHNICAL FIELD OF THE INVENTION

This invention relates to data transmission with a facsimile modem having a control channel and a primary channel for transmitting data wherein the control channel does not implement a training sequence to address echo rejection, and more particularly to the implementation of far echo rejection in the control channel.

### BACKGROUND

Certain data transmission systems using a facsimile (hereinafter referred to as “fax” or “facsimile” interchangeably) modem are known in the art for use with fax machines, fax telephones, multifunctional printers, fax servers, and the like. No echo canceller training sequence is included for initial facsimile transmissions, which commonly results in receipt of an echo by either the sending or receiving device during the transmission. Facsimile modems can be hardware modems or software modems. Modems convert digital information to analog by modulating it on the sending end and demodulating the analog information into digital information at the receiving end. Facsimile modems use a half duplex transmission mode wherein signals can be passed in either direction, but not simultaneously. When transmitting data in a facsimile call, a facsimile modem can use V.29, V.27ter, V.17, V.21 channel 2, or V.34 half duplex formats to communicate on a control channel. Both the receiver and transmitter occupy the same bandwidth. Bandwidth is the amount of data that can be transmitted via a given communications channel in a given unit of time (generally one second). The control channel provides information necessary for the respective remote ends of the call to receive. Typical information on the control channel includes machine capabilities, speed selection, page acknowledgements, and the like. During the time the control channel is used no user facsimile data is transmitted or received.

A general diagram of a facsimile transmission environment 100 is shown in FIG. 1, wherein a first data processing device 101 with a first modem functionality component 102 transmits data via a network connection 103, such as a telephone line, to a second data processing device 104 having a second modem functionality component 105. A Public Switched Transmission Network (PSTN) can be used with channel paths to and from both conventional wired and mobile wireless channels and devices. Such devices used for sending and receiving fax transmissions include fax machines, fax telephones, multifunctional printers, fax servers, and the like. The modem functionality components 102, 105 could be implemented as a soft modem, i.e. modem software operating on a system processor, or a hard modem in which modem software is operated at least in part on dedicated modem hardware resources.

When impedance mismatch of the remote modem's hybrid occurs compared to the complex line impedance, a portion of an original signal from a locally transmitted signal on a phone line is returned to the originating modem at the remote modem's hybrid resulting in receipt of a far echo signal. The far echo signal level is attenuated significantly in comparison to the actual remote signal. Round Trip Delay (RTD) refers to the amount of time it takes for the far echo to return to the local transmitter. Round Trip Delay varies from call to call depending on routing. The far echo signal arrives at the originating modem at an unknown time. This is contrasted with what is known as a local or “near echo” that can easily be eliminated by waiting an appropriate amount of time before turning the FSK (Frequency Shifted Keying) receiver on since the near echo only travels a short distance to the central office (CO) and back.

Most fax modems use a Frequency Shifted Keying (FSK) system, which is conceptually simple. An FSK system takes a sequence of binary data and converts a binary 1 to one tone and a binary 0 to another tone. No training sequence of any kind is necessary in an FSK system to send and receive data. The receiver only needs to differentiate between these two tones to demodulate the signal. For that reason, many Point of Sale (POS) terminals and other fax modems use an FSK system to reduce on-line time. However, a local FSK receiver has no ability to distinguish between its far echo signal and the actual remotely transmitted signal. This is true for both the originating modem and the answer modem. Under certain line conditions with significant far echoes, receiving a fax is impossible.

### SUMMARY OF THE INVENTION

With the advent of digital networks, far echo signals have increased as networks and phone systems include more digital components. In an FSK system used to transmit data via fax, no training sequence is included for sending and receiving data. Therefore, an FSK receiver cannot distinguish between its far echo signal and the actual remotely transmitted signal. The present invention provides one solution to the problem of echo received during a fax transmission which interferes with the fax transmission. An embodiment of the invention is a facsimile modem having a control channel and a primary channel for transmitting data which implements far echo rejection in the control channel. While it is understood that when transmitting data in a facsimile call, a facsimile modem can use V.29, V.27ter, V.17, V.21 channel 2, or V.34 half duplex formats to communicate on a control channel, one embodiment of the invention comprises a facsimile modem operating with a V.21 format.

In one embodiment, a known frame is transmitted by the calling modem, the receiving modem or both modems. Whichever modem transmits the known frame then monitors for echo of the sent frame that the transmitting modem sent. The detected echo level is measured and recorded. Any signals below a threshold based upon the echo level are rejected as being a far echo signal, thus eliminating far echo interference during a fax transmission. As described below, other features and variations can be implemented, if desired, and a related method can be utilized, as well.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1 is a generalized diagrammatic view of a portion of a facsimile modem environment;

FIG. 2 is a diagram of transmission steps for a fax transfer;

FIG. 3 is a flowchart of the far echo rejection process; and

FIG. 4 is a block diagram of a hardware modem.

### DETAILED DESCRIPTION OF THE INVENTION

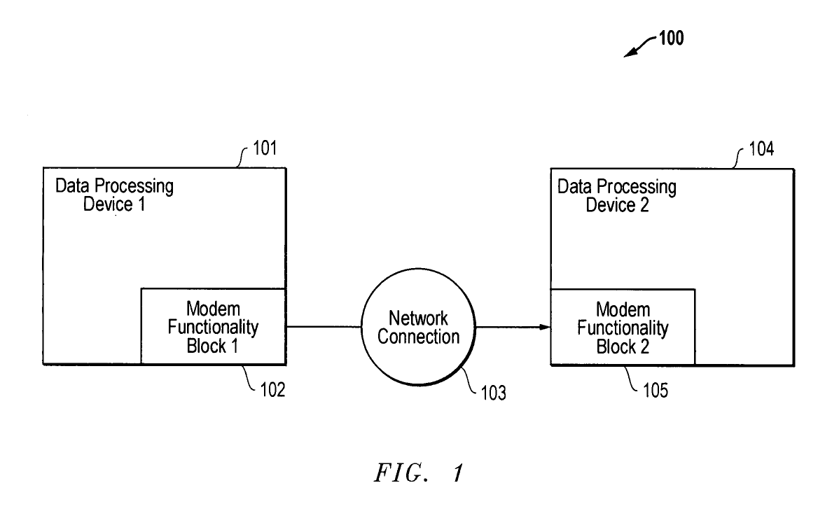

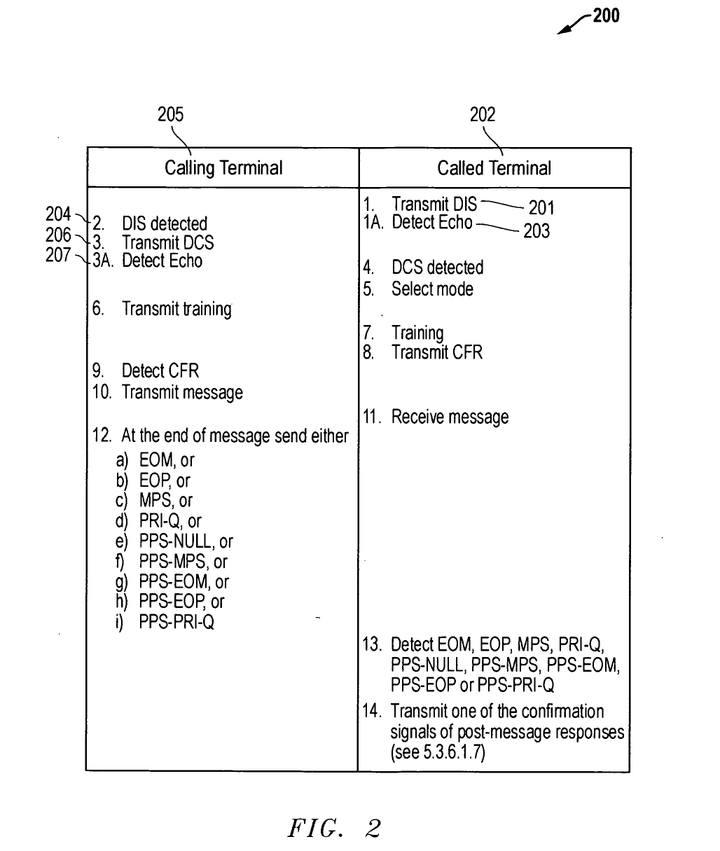

The present invention provides a facsimile modem having a control channel and a primary channel for transmitting data in the fax environment shown in FIG. 1, which implements far echo rejection in the control channel. FIG. 2 shows the transmission steps for a fax transfer with a V.21 modem format 200 that further includes additional steps for implementing the techniques disclosed herein. As described herein V.21 fax transmissions are discussed for illustrative purposes. It will be recognized that the techniques provided herein may be used for other fax transmission standards. The V.21 standard modem format supports asynchronous transmission at rates up to 300 baud. Steps 1 through 3A are most relevant to an exemplary embodiment. It is noted that most of the steps 1-12 may be merely the typical steps utilized in prior art V.21 fax transmissions. Steps 1A and 3A, however, are additional steps not taught in the prior art. In Step 1 201 after a fax communication is initiated by a calling modem, the called/receiving terminal 202 transmits a Digital Identification Signal (DIS) frame containing system identification information. A DIS frame contains particular ID information for the called fax machine. This frame is sent once as the initial control frame interchange begins. A Digital Command Signal (DCS) frame is sent by the called terminal upon detection of the DIS signal. As known in the art, DIS and DCS frames are HDLC frames that identify the receiving and sending parties as shown in Steps 1 through 3.

Step 1A 203 is echo detection by the called/receiving terminal 202 wherein a signal level is determined for the detected echo of the sent DIS frame. Thereafter, any signal at the called/receiving terminal that is below the detected echo signal level is rejected as a far echo signal. In Step 2 204, the calling/sending terminal 205 detects the DIS frame sent by the called/receiving terminal and sends a DCS frame in Step 3 206. Echo at the calling terminal is detected in Step 3A 207 by detecting an echo of the DCS frame. Subsequent signals at the calling terminal are rejected if the signals received by the calling terminal are below the signal level determined in Step 3A 207. Exemplary techniques for performing the echo detection steps 1A 203 and 3A 207 are described below.

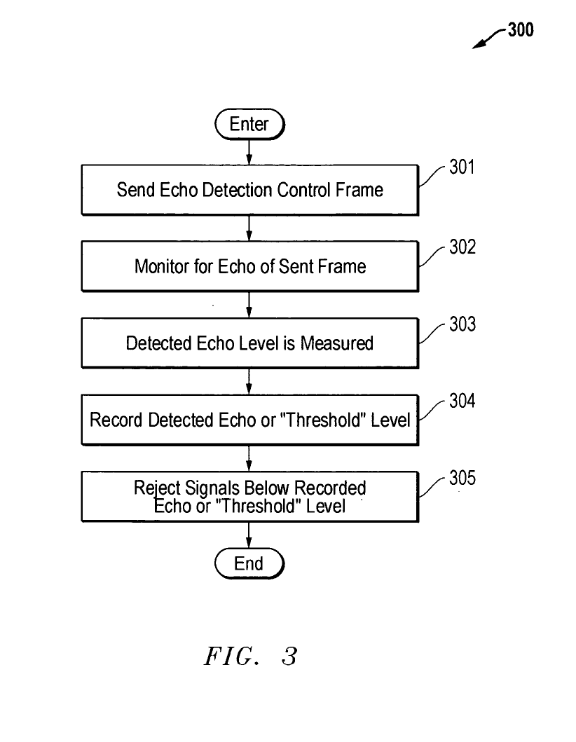

FIG. 3 shows a flowchart 300 of the steps involved in an embodiment of fax modem far echo rejection. More particularly, FIG. 3 describes an embodiment of the present invention for eliminating echo during the first steps of a fax transmission as described in FIG. 2. As described herein the techniques will be described with reference to the echo detection at the called/receiving terminal (such as step 1A 203 of FIG. 2). It will be recognized however that these same techniques are applicable at the calling terminal (such as for example step 3A 207 of FIG. 2). For initiation of the echo detection technique, control frames are sent by a called/receiving terminal, step 301. The echo detection control frame may merely be a known frame of data for which the called/receiving terminal will subsequent look for a return echo. For this reason it is desirable that the echo detection control frame be a frame of data that is not normally expected to be received by the modem performing the rejection in standard fax control channel communications. For example the echo detection control frame at the called/receiving terminal may be an echo of the DIS frame that the called/receiving terminal sends. Similar the echo detection control frame at the calling/sending terminal may be an echo of the DCS frame that the calling/sending terminal sends. In this manner, frames that are part of the normally required fax machine identification interchange may also be utilized as echo control frames used in the echo rejection process. Thus, though exemplary embodiments of an echo control frame described herein include the use of a DCS and/or DIS frame it will be recognized that many other frames may be utilized as the echo control frame. For example, other known frames that are part of any fax interchange may also be utilized as an echo control frame or alternatively, special frames used solely as an echo control frame may also be added to the interchange. When used in such a manner, the frames may thus also be known as echo control frames. Thus, an echo control frame may be dedicated to detecting echo or in one advantageous embodiment of the techniques disclosed herein a frame may have a dual use of which one use is as the echo control frame and another use serves some other purpose of the fax interchange. Such a dual use of an existing frame results is particularly advantageous in that this allows the techniques described herein to be adapted for use in a wide variety of transmission standards without requiring changes in the typical transmission exchanges. It will be recognized, however, that the echo control frame could alternatively also be a dedicated echo control frame that is sent by a terminal for the sole purpose of performing echo detection.

Next, the called/receiving terminal monitors for far echo of the sent echo detection control frame, step 302. The detected far echo level is measured by the called/receiving terminal, step 303, by measuring the signal level of the echo detection control frame echo that is identified in step 302 by the called/receiving terminal. The echo level that is measured in step 303 (or alternatively a threshold level based upon the echo level as described below) is then recorded or saved by the called/receiving terminal, step 304. A threshold level may be set based upon the measured detected echo level. Any signals below the threshold level are rejected or ignored at the called/receiving terminal based upon the echo level, step 305. Utilizing the process of FIG. 3 will thus result in the elimination of far echo signals during the fax transmission.

The threshold level may be set to merely match the detected echo level. However, variations may exist over time even within a single fax session such that setting of the threshold level to the original detected echo level may not rejected some subsequent far echoes that happen to exceed the original echo level detected through steps 301-303. Thus, it may be desirable to set the threshold level to some level above the original detected echo level. For example, the threshold level may be set to 3.5 dB above the detected echo level of step 303. In another even more robust alternative the threshold level may be sent to be 7 dB above the detected echo level of step 303. In such an embodiment, any signals detected that have a signal strength less than this 7 db level will be rejected as being far echo signals. In this manner, far echoes will be eliminated in the fax transmission process even if the echo is somewhat greater than the original echo to which the modem was calibrated.

Generally it may not be known specifically whether a far echo exists on the line or not. Hence the called/receiving terminal may or may not receive an echo version of its' control frame (for example the DIS frame sent by the called/receiving terminal may or may not be echoed back to the called/receiving terminal). However, if the called/receiving terminal receives the expected response control frame from the calling/sending terminal (for example the DCS frame) before detecting any other frame then one can assume far echo doesn't exist or is at a level that can be ignored. In this case, the echo rejection algorithm can be bypassed. Similarly, the echo rejection algorithm may be bypasses at the calling/sending terminal if no echo is detected at that terminal. If at a one modem that sends a control frame the next received frame is not the expected response from the other modem, in one embodiment this may be assumed to be an echoed version of the control frame sent by the one modem. Alternatively, a more advanced algorithm may be used in which the content of a believed to be received echo is analyzed to confirm that it is in fact an echo of a control frame that the particular modem had sent.

As mentioned above, this procedure may be repeated at the calling fax terminal also. Thus, techniques are provided in which far echo signals may be rejected or eliminated from a fax transmission session even though the corresponding fax standard may not include a training algorithm. As described herein the process is characterized as echo rejection, however, it will be recognized that as used herein the term “rejection” is used to designate any of variety of methods that address the impact of echo including cancellation, removal, filtering, etc. Moreover, even though the techniques described herein are presented as being desirably performed on both ends of a fax transmission session, such use at both terminals is not required. Thus, one or the other terminal may solely perform the echo rejection techniques described herein without requiring the other modem to participate in the echo rejection process. In this way the techniques provided herein may be implemented unilaterally on a given modem without requiring the modem standard to be modified to achieve echo rejection at one end of the fax session. Further, the techniques described herein do not interfere with operations of the control channel communications of various fax standards and thus are compatible with existing modem standards.

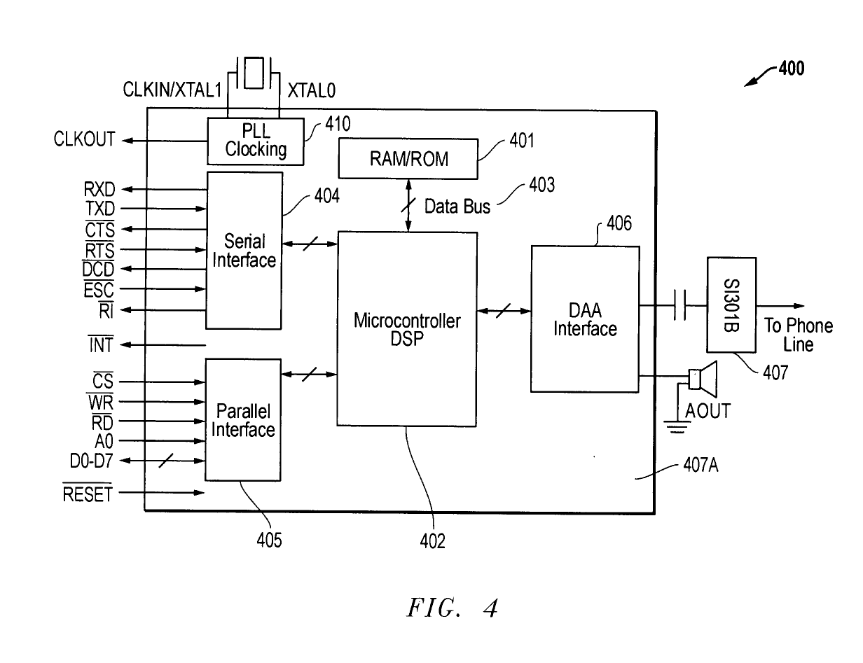

The techniques described herein may be utilized with a wide variety of fax modems. For example, such techniques may be implemented in soft modems or within hard modems. FIG. 4 shows an exemplary system of a hardware modem 400 within which the techniques described herein may be implemented. As shown in FIG. 4, the hardware modem may include a system side integrated circuit 407A and a line side integrated circuit 407 that are coupled together through an isolation barrier (such as for example a capacitive isolation barrier). The line side integrated circuit 407 may be coupled to a phone line. Such hardware modems are known in the art for example the Silicon Laboratories Si24xx IsoModem product line.

As shown in FIG. 4, an exemplary hardware modem may include Random Access Memory (RAM)/Read Only Memory (ROM) 401, a microcontroller (DSP) 402, a data bus 403, interfaces 404, 405 and 406, and a PLL clock 410 as shown. It will be recognized that the hardware shown is exemplary only and the techniques described herein may be utilized with a wide range of hardware/software modem solutions. In the example shown of FIG. 4, the techniques described herein may be incorporated with program instructions contained within the modem. For example, software program instruction code that performs the techniques described herein may be provided within the Random Access (RAM)/Read Only Memory (ROM) 401 or stored directly within the microcontroller DSP 402. In this manner, the microcontroller DSP 402 may be programmed to carry out the far echo rejection techniques described herein.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. A method of transmitting data with a facsimile modem, comprising:
utilizing a control channel and a primary channel for transmitting data according to a modem standard wherein said control channel does not implement a training sequence to address far echo effects; and
implementing a far echo rejection at a first terminal of a facsimile modem session by utilizing control channel communications, the implementation of the far echo rejection being achievable even if a second terminal of the facsimile modem session does not implement the far echo rejection.

2. The method of claim 1, further comprising:
transmitting a known echo rejection control frame;
monitoring for an echo of the sent echo detection control frame;
measuring a detected echo level; and
rejecting subsequent signals below a signal threshold that is based at least in part upon the detected echo level.

3. The method of claim 2 wherein the known echo rejection control frame is a fax identification control frame.

4. The method of claim 3 wherein the fax identification control frame is a Digital Identification Signal (DIS) or Digital Command Signal (DSC) frame.

5. The method of claim 2, wherein the threshold is set to 3.5 dB or less above the detected echo level.

6. The method of claim 2, wherein the threshold is set to 7 dB or less above the detected echo level.

7. The method of claim 2, wherein the called/receiving terminal transmits the known echo detection control frame.

8. The method of claim 2, wherein the calling/sending terminal transmits the known echo detection control frame.

9. The method of claim 2, wherein both the calling/sending terminal and the called/receiving terminal transmit the known echo detection control frame.

10. The method of claim 9, wherein the far echo rejection is implemented within a hardware modem.

11. A facsimile transmission system, comprising:
transmitting data over a primary channel;
controlling the transmission of said data via a control channel according to a facsimile transmission standard; and
performing far echo rejection directly in the control channel.

12. The system of claim 11, wherein the system is a hardware modem.

13. The system of claim 11, further comprising:
monitoring for echo of a sent control frame;
measuring a detected echo level; and
rejecting signals below a threshold based upon the detected echo level.

14. The system of claim 13 wherein the sent control frame is a fax identification control frame.

15. The method of claim 14 wherein the fax identification control frame is a Digital Identification Signal (DIS) or Digital Command Signal (DSC) frame.

16. The system of claim 11, wherein the threshold is set at 7 dB above the measured detected echo level.

17. The system of claim 11, wherein signals at or above the threshold level are received as incoming facsimile signals.

18. The system of claim 17, wherein modem transmission standard is the V.21 standard.

19. A computer program having code recorded on a computer readable medium for transmitting data via a facsimile transmission system, comprising:
transmitting data over a primary channel;
controlling the transmission of said data via a control channel according to a facsimile transmission standard wherein said control channel does not implement a training sequence to address far echo rejection; and
performing far echo rejection directly in the control channel.

20. The computer program of claim 19, further comprising:
transmitting a known echo detection control frame;
monitoring for an echo of the sent echo detection control frame;
measuring a detected echo level; and
rejecting subsequent signals below a signal threshold that is based at least in part upon the detected echo level.

21. The system of claim 20 wherein the known echo detection control frame is a fax identification control frame.

22. The method of claim 21 wherein the fax identification control frame is a Digital Identification Signal (DIS) or Digital Command Signal (DSC) frame.

23. The computer program of claim 22, wherein the threshold is set to 3.5 dB or less above the detected echo level.

24. The computer program of claim 22, wherein the threshold is set to 7 dB or less above the detected echo level.

25. The computer program of claim 22, wherein signals at or above the threshold level are received as incoming facsimile signals.

26. The computer program of claim 25, wherein modem transmission standard is the V.21 standard.
